(19) United States
(12) Patent Application Publication
(10) Pub. No.: US 2009/0300372 A1
(43) Pub. Date: Dec. 3, 2009

(54) SOLID STATE DISK AND INPUT/OUTPUT METHOD

(75) Inventors: Woo-Hyun LEE, Seoul (KR); Ji-Soo KIM, Yongin-si (KR); Bum-Seok YU, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/464,914

(22) Filed: May 13, 2009

(30) Foreign Application Priority Data
May 28, 2008 (KR) 10-2008-0049774

(51) Int. Cl. G06F 12/14

(52) U.S. Cl. 713/193

(57) ABSTRACT

Disclosed is a solid state disk including a storage unit configured to store data, and a control part configured to control enciphering and writing operation for the data using a key value and an initialization vector. The initialization vector is generated by processing an address corresponding to the data.

### CROSS-REFERENCE TO RELATED APPLICATIONS

This U.S non-provisional patent application claims priority under 35 U.S.C § 119 to Korean Patent Application No. 10-2008-0049774 filed on May 28, 2008, the subject matter of which is hereby incorporated by reference.

### BACKGROUND

The present invention relates to a solid state disk. More particularly, the present invention relates to a device and method capable of ciphering and deciphering all large-volume data associated with a solid state disk.

As contemporary electronic devices are increasingly mobile and smaller in size, some design trends have moved away from the use of conventional Hard Disk Drive (HDD) units as bulk data storage components. In many instances, the flash memory-based Solid State Disk (SSD) has replaced the HDD and other magnetic disk devices. When compared to conventional HDDs, the SSD is relatively disadvantageous in its overall storage capacity and cost. But it is also relatively advantageous in its data access speed, overall size, and resistance to mechanical impact. Ongoing development efforts related to fabrication processes for and design adaptations of the SSD can be expected to increase data storage capacity and decrease cost. Hence, it is expected that in the near future, the magnetic disk device may be replaced by the SSD in many applications.

As the SSD is increasingly incorporated in electronic devices (e.g., laptop computers, portable audio/video systems) as a bulk data storage device, its control unit is an essential interface between the constituent flash memory and the others components forming the device. In essence, the control unit administers data exchange according to a defined protocol. Many conventional computer systems use the so-called “Advanced Technology Attachment or ATA” to exchange data with conventional HDDs. The ATA is essentially a data transfer standard promulgated by IBM corporation defining an exchange of data between a host device and conventional HDDs. Any bulk data storage interface, such as those associated with a SSD, must competently implement the ATA in order to be backwards compatible with legacy software and existing data exchange protocols. Yet, SSD controllers must establish an interface with a flash memory, not some type of magnetic disk. A device for controlling the overall data transfer between a SSD and a corresponding host device will hereafter be referred to as a SSD controller.

### SUMMARY OF THE INVENTION

Embodiments of the invention are directed to a device and method capable of ciphering and deciphering bulk data communicated to/from a solid state disk (SSD) without excessively burdening a host device processor.

One embodiment of the invention provides a solid state disk comprising; a storage unit configured to store data, and a control part configured to control an enciphering and writing operation associated with the data using a key value and an initialization vector, wherein the initialization vector is generated by processing an address corresponding to the data.

In another embodiment, the invention provides an input/output method adapted for use with a solid state disk the method comprising; receiving externally provided data and a corresponding address, scrambling the data and an initialization vector, and enciphering the scrambled data using a key value, wherein the initialization vector is generated by processing the address.

In another embodiment, the invention provides a host system comprising; a central processing unit (CPU), and a non-volatile bulk data storage device storing data provided by the CPU, wherein the non-volatile bulk data storage device comprises; a storage unit configured to store the data, and a control part configured to scramble the data and an initialization vector, encipher the scrambled data using a key value, and store the enciphered data in the storage unit, wherein the control part is further configured to decipher the enciphered data retrieved from the storage unit using the key value, scramble the deciphered data and the initialization vector, and read the scrambled data, and the initialization vector is generated by processing an address corresponding to the data.

### BRIEF DESCRIPTION OF THE FIGURES

Non-limiting and non-exhaustive embodiments will be described with reference to the following figures, wherein like reference numerals refer to like or similar elements. In the figures:

FIG. 1 is a block diagram of a solid state disk (SSD) according to an embodiment of the invention.

FIG. 2 is a block diagram further illustrating the SSD controller of FIG. 1.

FIG. 3 shows an exemplary original image produced by a video device incorporating an SSD.

FIG. 4 illustrates image data obtained by enciphering the original image of FIG. 3 in an Electronic CodeBook (ECB) mode of operation.

FIG. 5 shows data obtained by enciphering the original image of FIG. 3 in a Cipher Block Chaining (CBC) mode.

FIG. 6 is a block diagram showing an encryption process according to an embodiment of the invention.

FIG. 7 is a block diagram showing a decryption process according to an embodiment of the invention.

FIG. 8 is a block diagram further illustrating an Advanced Encryption Standard (AES) associated with the embodiment of FIG. 7.

FIG. 9 is a conceptual block diagram showing an exemplary cipher and decipher operations assuming the AES of FIG. 8 is used in relation to defined data sectors.

FIG. 10 is a conceptual block diagram showing cipher and decipher operations conducted based upon sectors when an initialization vector is generated by a host CPU.

FIG. 11 is a block diagram showing a system including a solid state disk (SSD) according to an embodiment of the invention.

FIG. 12 is a block diagram showing a system including a hard disk according to another embodiment of the invention.

FIG. 13 is a block diagram showing a system including an optical disk according to yet another embodiment of the invention.

### DESCRIPTION OF EMBODIMENTS

Conventionally, in many types of electronic devices when important data was stored in a bulk data storage device such as a hard disk (HD) or a Solid State Disk (SSD), it was not enciphered. If the data storage device or host system were breached during an unauthorized access (i.e., “hacked”), it was impossible to ensure the reliability of the stored data within subsequent system operations. Accordingly, it has become necessary to encipher all or at least a significant portion of the data stored in a bulk storage device.

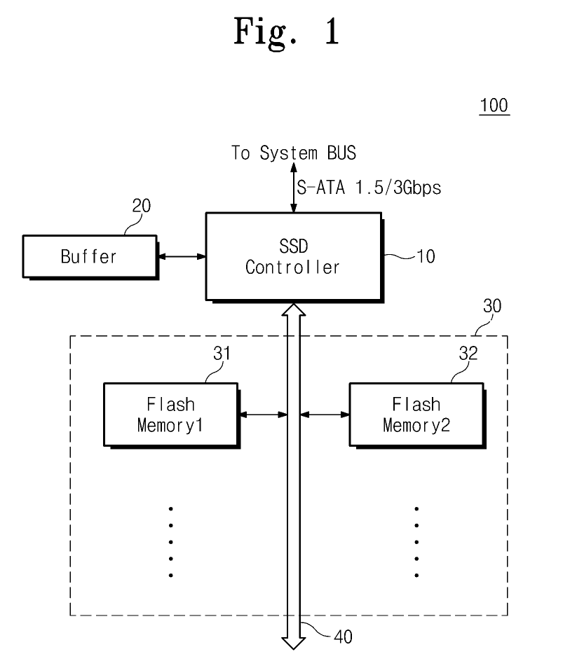

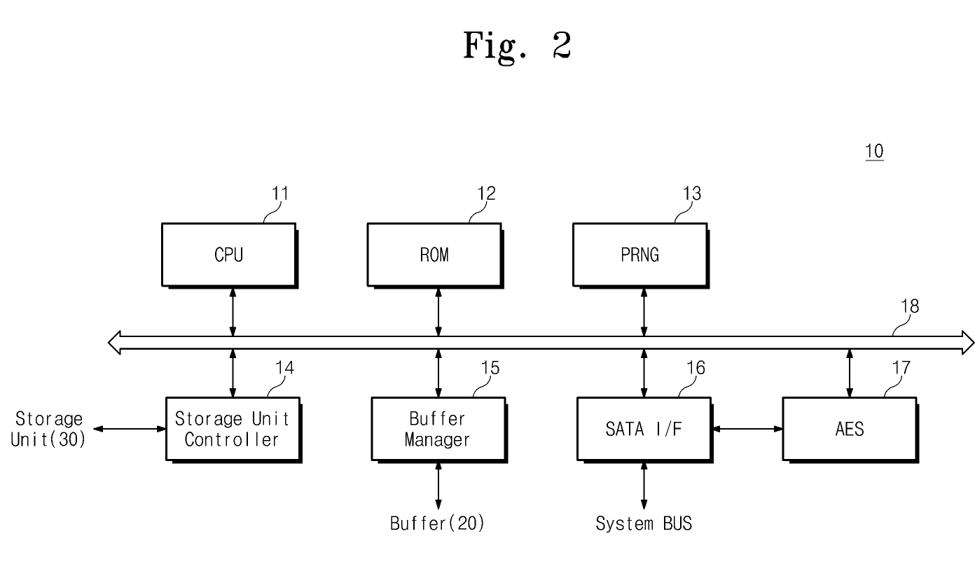

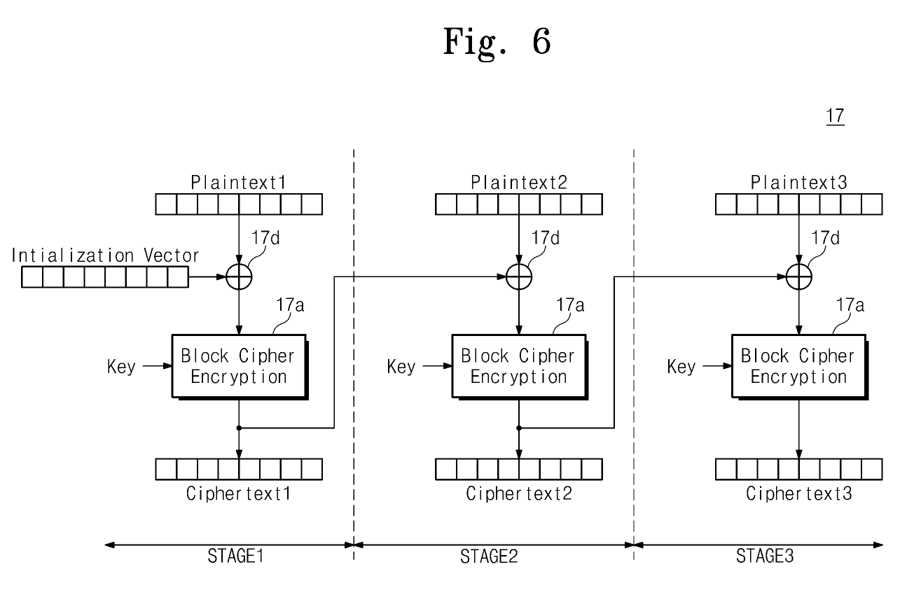

An exemplary host device (e.g., a computer system) is illustrated in the block diagrams of FIGS. 1 and 2. This type of host device is capable of incorporating certain embodiments of the invention with provide cipher/decipher operations for stored data. FIGS. 6 through 9 that follow further describe a computer system using a Cipher Block Chaining (CBC) mode of operation in relation to certain embodiments of the invention. In various embodiments of the invention, the constituent bulk data storage device may be implemented using a conventional solid state disk (SSD), hard disk (HD), optical disk, and/or the like.

Figure (FIG.) 1 is a partial block diagram showing a SSD according to an embodiment of the invention. Referring to FIG. 1, a computer system 100 includes in relevant portion a solid state disk (SSD) controller 10, a buffer 20, a storage unit 30, and a bus 40.

The computer system 100 is configured to store data transferred from by a system bus (not shown) at a first data transfer rate (e.g., 1.5 Gpbs or 3.0 Gbps) using a conventional S-ATA1 or S-ATA2 interface. Such externally provided data may be placed in the buffer 20 before being stored in storage unit 30 by means of bus 40. In the illustrated embodiment, data stored in the storage unit 30 is defined in relation to a plurality of sectors. Storage unit 30 is further assumed to be implemented using a plurality flash memory devices, but any competent form of solid-state non-volatile memory may be used. FIG. 1 shows an example where the storage unit 30 includes first and second flash memories 31 and 32. But, it will be apparent to one skilled in the art that the particular number, type and configuration memories forming the storage unit 30 is a matter of design choice.

FIG. 2 is a block diagram further illustrating the SSD controller of FIG. 1. Referring collectively to FIGS. 1 and 2, the SSD controller 10 is assumed to comprise a CPU 11, a Read-Only-Memory (ROM) 12, a Pseudo-Random Number Generator (PRNG) 13, a storage unit controller 14, a buffer manager 15, an SATA interface 16, and an Advanced Encryption Standard (AES) block 17. These components are connected for data transfer purposes by controller bus 18.

CPU 11 generally controls the operation of ROM 12, PRNG 13, storage unit controller 14, buffer manager 15, SATA interface 16, and AES 17. ROM 12 will typically store BIOS information used to boot the host computer system 100. However, in other embodiments, BIOS information may be stored in the storage unit 30.

PRNG 13 is used to generate key values under the control of CPU 11. In the illustrated embodiment, PRNG 13 is assumed to generate a key value differently whenever the computer system 100 is booted, and the key value is then stored in storage unit 30. If a key value erase command is executed by CPU 11, the key value stored in the storage unit 30 is erased. Once an existing key value is erased, it is impossible to restore data in the storage unit 30 using said key value.

The storage unit controller 14 controls the operation of storage unit 30, and the buffer manager 15 generally controls the buffer 20 of FIG. 1. The buffer 20 may be embodied by one of a SDRAM, DDR SDRAM, DDR2 SDRAM, and DDR3 SDRAM. The SATA interface 16 generally receives data from a host system bus using, it is assumed, an ATA interface compatible protocol.

AES block 17 enciphers data received from the SATA interface 16 based on the provided key value and an initialization vector. Further, the AES block 17 deciphers enciphered data stored in the storage unit 30 using the key value and the initialization vector. The initialization vector may be generated by processing the address of a sector in accordance with a command received from the SATA interface 16.

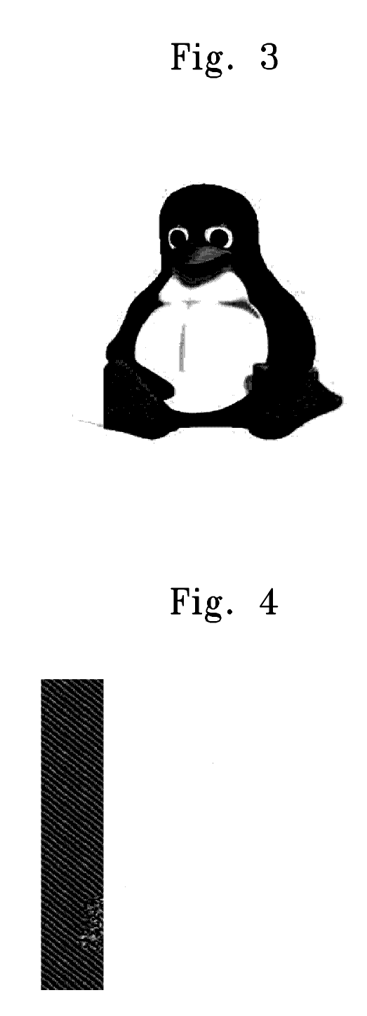

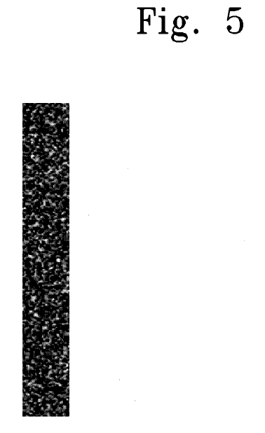

For example, it is assumed that the host device 100 includes a video image capability (e.g., a digital camera) capable of obtaining an image and generating corresponding image data. An exemplary original image (i.e., a penguin image) is shown in FIG. 3. The image data associated with this original image is enciphered during a conventionally understood Electronic CodeBook (ECB) mode of operation, as illustrated in FIG. 4. The enciphered image data derived from the original image is otherwise illustrated in relation to a conventionally understood Cipher Block Chaining (CBC) mode operation in FIG. 5.

The ECB mode is a mode wherein an image is enciphered by use of only a key value. Referring to FIG. 4, an original image is estimated from an image enciphered in the ECB mode. That is, referring to FIG. 4, an original image (i.e., penguin figure) may be estimated via a difference of light and shade.

Thus, it is necessary to scramble and encipher data by use of an initialization vector, which is accomplished by the CBC mode encryption. Referring to FIG. 5, the original image is now further enciphered in a CBC mode of operation, and it is impossible to estimate the original image from an enciphered image data in the CBC mode. In general, the CBC mode encryption may be used for high-level encryption.

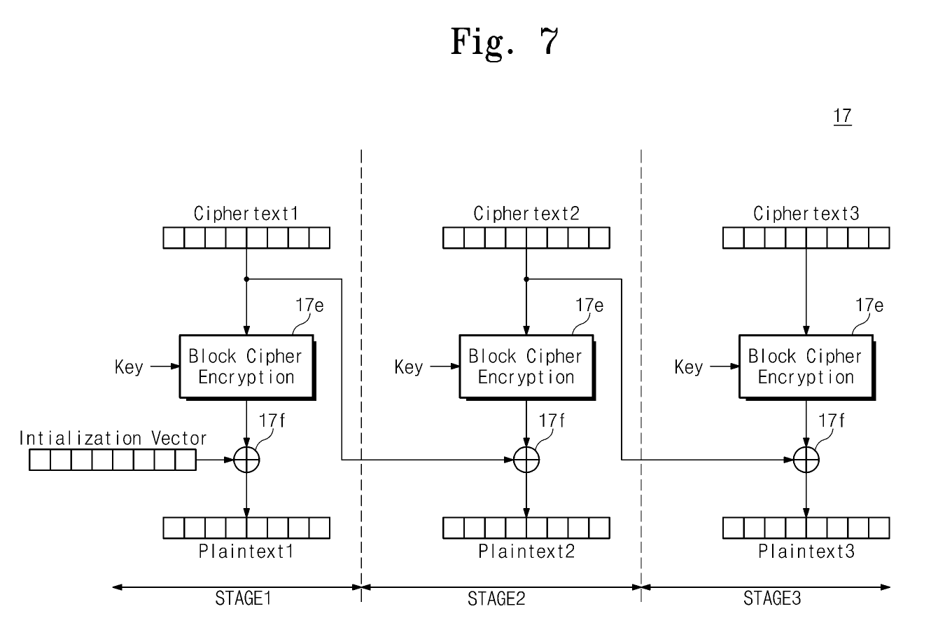

An encryption process according to one embodiment will be described with reference to FIG. 6, and a corresponding decryption process will be described with reference to FIG. 7. Further, a method of generating an initialization vector will be more fully described with reference to FIGS. 8 through 10.

FIG. 6 is a block diagram showing an encryption process according to an embodiment of the invention. This encryption process assumes a CBC mode.

Referring to FIG. 6, AES block 17 may include a block cipher encryption part 17a and an exclusive-OR gate 17d.

Within a first stage, the block cipher encryption part 17a converts a plain text into a cipher text. The exclusive-OR gate 17d scrambles the plain text and an initialization vector. That is, in the illustrated embodiment, the scramble operation is assumed to use the logical operation of the exclusive-OR gate 17d.

The exclusive-OR gate 17d scrambles the first plain text with the initialization vector, and the scrambled result is sent to the block cipher encryption part 17a. The block cipher encryption part 17a converts the scrambled result into the first cipher text by using a key value.

Within a subsequent second stage, the exclusive-OR gate 17d scrambles the second plain text and the first cipher text, and the scrambled result is sent to the block cipher encryption part 17a. The block cipher encryption part 17a converts the scramble result into the second cipher text using a key value.

Within a third stage, the exclusive-OR gate 17d scrambles the third plain text and the second cipher text, and the scrambled result is sent to the block cipher encryption part 17a. The block cipher encryption part 17a converts the scramble result into the third cipher text using a key value.

For convenience of description, three block cipher encryption parts 17a and three exclusive-OR gates 17d are illustrated in FIG. 6 in order to describe a sequential operation. But, the AES block may include as few as a single block cipher encryption part 17a and one exclusive-OR gate 17d.

FIG. 7 is a block diagram showing a decryption process according to an embodiment of the invention. Here again, the exemplary decryption process assumes a CBC mode. Referring to FIG. 7, AES block 17 includes a block cipher decryption part 17e and an exclusive-OR gate 17f. The block cipher decryption part 17e converts a cipher text into a plain text. The exclusive-OR gate 17f descrambles the decryption result using an initialization vector.

Within a first stage, the block cipher decryption part 17e deciphers the first cipher text using a key value. The exclusive-OR gate 17f descrambles the deciphered result and the initialization vector to generate the first plain text.

Within a second stage, the block cipher decryption part 17e deciphers the second cipher text using a key value. The exclusive-OR gate 17f descrambles the deciphered result and the first cipher text to generate the second plain text.

Within a third stage, the block cipher decryption part 17e deciphers the third cipher text using a key value. The exclusive-OR gate 17f descrambles the deciphered result and the second cipher text to generate the third plain text.

For convenience of description, three block cipher decryption parts 17e and three exclusive-OR gates 17f are illustrated in FIG. 7 in order to describe a sequential operation. But, AES block 17 may include as few as a single block cipher decryption part 17e and one exclusive-OR gate 17f.

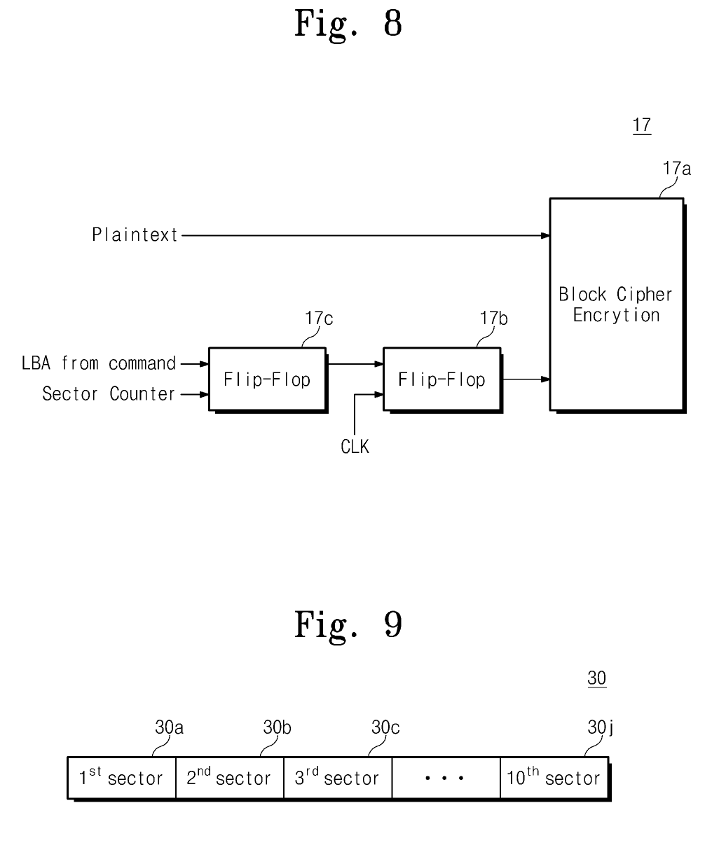

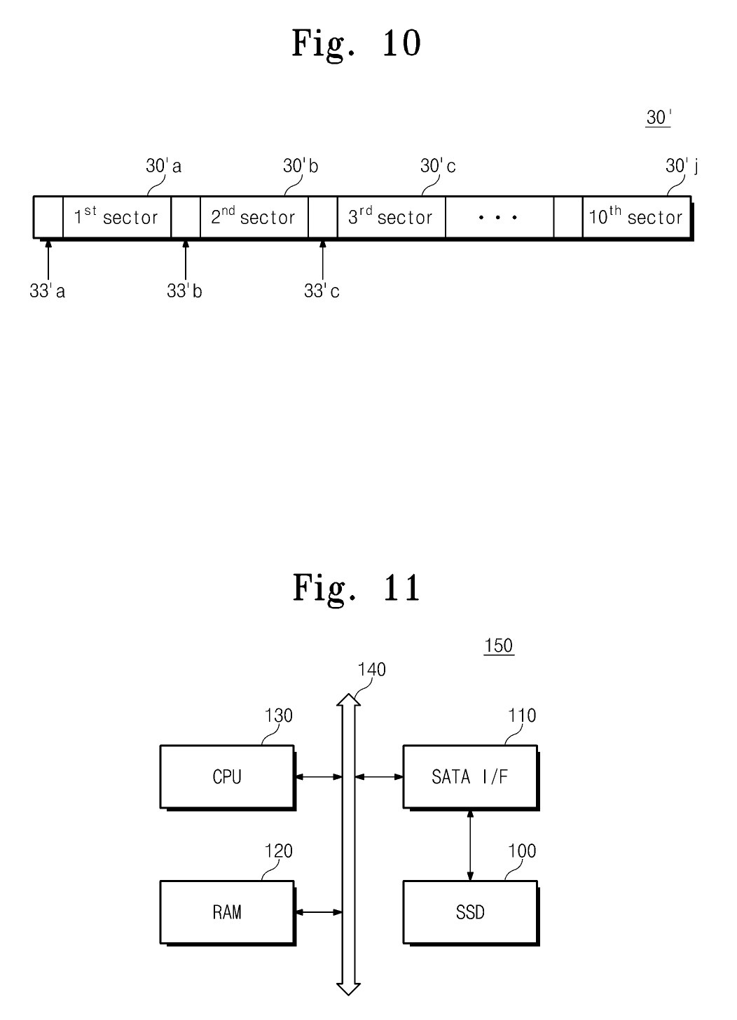

The performance of the computer system according to exemplary embodiments of the invention is controlled, at least in part, according to how an initialization vector is generated and how the initialization vector is allotted. An initialization vector allotting method according to an exemplary embodiment of the invention will be described with reference to FIGS. 8 and 9, and processes of generating, allotting, and storing an initialization vector under the control of CPU 11 will be more fully described in relation to FIG. 10.

FIG. 8 is a block diagram showing Advanced Encryption Standard (AES) illustrated in FIG. 7. Referring to FIG. 8, AES block 17 includes a block cipher encryption part 17a, a flip-flop 17b, and an adder 17c.

The adder 17c receives a sector address corresponding to a Logical Block Addressing (LBA) requested by the host system. If a command requested by host system is a burst command, the adder 17c further receives count information for the identified sector.

For example, if a command requested by the host system is not a burst command, then adder 17c provides only an address for the identified sector. However, if the command requested by the host system is a burst command, adder 17c provides a sector address and count information. That is, a count value is increased whenever a sector address is accessed.

The flip-flop 17b temporarily stores an output of the adder 17c and outputs it to the block cipher encryption part 17a. That is, the flip-flop 17b stores a unique address corresponding to each sector.

The block cipher encryption part 17a receives the unique address corresponding to each sector to convert it to an initialization vector. For example, if an address for a corresponding sector is a 48-bit address, since an initialization vector is 16-byte (128 bits), 80 dummy bits are added to front and rear parts of the address. Thus, a computer system according to the exemplary embodiments may have different initialization vectors with respect to all sectors.

FIG. 9 shows that cipher and decipher operations of the AES in FIG. 8 are conducted based upon sectors.

Referring to FIGS. 4, 5, 8, and 9, storage unit 30 according to the various embodiments of the invention may be partitioned into first through tenth sectors 30a to 30j. It will be apparent to one skilled in the art that such a configuration of the storage unit 30 is a matter of design choice.

An address requested by the host system is sent to AES block 17 via SATA interface 16. AES block 17 receives the sector address from SATA interface 16 to generate an initialization vector using the received address.

AES block 17 may encipher requested data using the initialization vector and a key value by operation of pseudo-random number generator 13 to write the enciphered data. Or, AES block 17 may decipher requested data using the initialization vector and a key value by operation of pseudo-random number generator 13 to read the deciphered data. Thus, the computational burden enciphering and deciphering may be removed from CPU 11. Further, enciphering and writing of data via AES 17 or deciphering and reading of data via AES 17 is conducted during a time when data for each sector is transmitted and received via SATA interface 16.

FIG. 10 shows that cipher and decipher operations are conducted based upon sectors when an initialization vector is generated by CPU 11.

Referring to FIGS. 4, 5, and 10, a storage unit 30′ is partitioned into first through tenth sectors 30′a to 30′j. CPU 11 generates an initialization vector for each sector and allots each initialization vector to AES block 17 whenever the sector is accessed. Further, CPU 11 stores the generated initialization vector in the storage unit 30′. There are required times 33a to 33c taken to generate an initialization vector and transfer it to AES block 17 under the control of CPU 11. AES block 17 may encipher required data using the initialization vector and a key value from pseudo-random number generator 13 and write the enciphered data. Or, AES block 17 may decipher required data using the initialization vector and a key value from random number generator 13 and read the deciphered data.

Since CPU 11 performs operations for generating and transferring an initialization vector before enciphering/deciphering, the peak resource load associated with performance of full disk encryption is reduced. However, in practice, it is impossible to realize an operation of setting firmware needed to generate and transfer an initialization vector via CPU 11 after stopping a link whenever each sector is accessed.

FIG. 11 is a block diagram showing a host system 150 including a solid state disk (SSD) according to an embodiment of the invention. Referring to FIG. 11, a SSD based host system generally includes SSD 100, an SATA interface 110, RAM 120, CPU 130, and a bus 140.

A SSD, such as those described with reference to FIGS. 1 through 10, may be used in this type of embodiment. CPU 130 accesses SSD 100 via SATA interface 110 connected with bus 140. RAM 120 is used as a host system memory. SSD 100 enciphers and stores data provided by CPU 130, and deciphers and reads data requested by CPU 130.

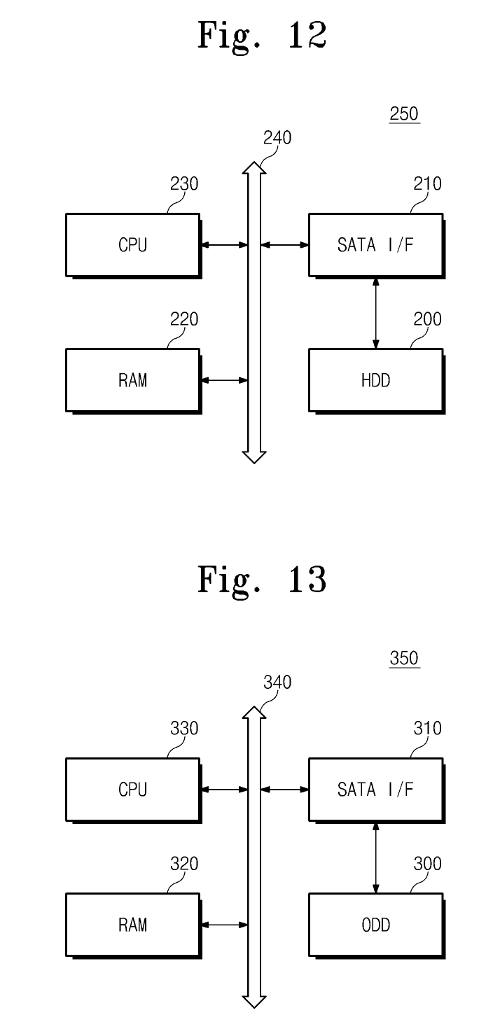

FIG. 12 is a block diagram showing a host system including a hard disk according to another embodiment of the invention. Referring to FIG. 12, a hard disk system 250 includes a hard disk drive (HDD) 200, SATA interface 210, RAM 220, CPU 230, and a bus 240. HDD 200 may be a conventional hard disk drive compatible with an SATA1 or SATA2 interface.

CPU 230 accesses HDD 200 via SATA interface 210 connected with bus 240. RAM 220 is used as the host system memory. HDD 200 enciphers and stores data provided by CPU 230, and deciphers and reads data requested by CPU 230.

FIG. 13 is a block diagram showing a host system including an optical disk according to yet another embodiment of the invention. Referring to FIG. 13, an optical disk system 350 includes an optical disk drive (ODD) 300, SATA interface 310, RAM 320, CPU 330, and a bus 340.

ODD 300 may be an optical disk drive capable of being written to using an SATA1 or SATA2 interface. For example, ODD 300 may be one of CD-RW, DVD−RW, DVD+RW, DVD-RAM, and Blu-RaY.

CPU 330 accesses ODD 300 via SATA interface 310 connected with bus 340. RAM 320 is used as the host system memory. ODD 300 enciphers and stores data provided by CPU 330, and deciphers and reads data requested by CPU 330.

A host system, such as a computer system, according to an embodiment of the invention may be configured to encipher and write (or decipher and read) data without forcing the related computational burdens onto the host system CPU by using an address requested by the host system as an initialization vector. Further, since an initialization vector is generated using a unique sector address, the host system does not need to store initialization vectors for a plurality of sectors.

The above-disclosed subject matter is to be considered illustrative, and not restrictive, and the appended claims are intended to cover all such modifications, enhancements, and other embodiments, which fall within the scope of the invention. Thus, to the maximum extent allowed by law, the scope of the exemplary embodiments is to be determined by the broadest permissible interpretation of the following claims and their equivalents, and shall not be restricted or limited by the foregoing detailed description.

What is claimed is:

1. A solid state disk comprising:
a storage unit configured to store data; and
a control part configured to control an enciphering and writing operation associated with the data using a key value and an initialization vector,
wherein the initialization vector is generated by processing an address corresponding to the data.

2. The solid state disk of claim 1, further comprising:
a buffer configured to temporarily store the data.

3. The solid state disk of claim 2, wherein the buffer is one selected from a group consisting of; a SDRAM, DDR SDRAM, DDR2 SDRAM, and DDR3 SDRAM.

4. The solid state disk of claim 1, wherein the control part comprises a pseudo-random number generator configured to generate the key value.

5. The solid state disk of claim 1, wherein the initialization vector is generated by adding dummy bits to the address.

6. The solid state disk of claim 1, wherein the control part is further configured to scramble the initialization vector and the data via an exclusive-OR logic operation.

7. The solid state disk of claim 1, wherein the storage unit is configured in a plurality of sectors.

8. The solid state disk of claim 1, wherein the storage unit is implemented using a plurality of flash memories.

9. The solid state disk of claim 1, wherein the storage unit stores the key value.

10. An input/output method adapted for use with a solid state disk the method comprising:
receiving externally provided data and a corresponding address;
scrambling the data and an initialization vector; and
enciphering the scrambled data using a key value,
wherein the initialization vector is generated by processing the address.

11. The input/output method of claim 10, further comprising:
writing the enciphered data to a non-volatile bulk data storage device.

12. The input/output method of claim 11, further comprising:
retrieving the enciphered data from the non-volatile data storage device and deciphering the enciphered data using the key value; and
descrambling and outputting the deciphered data and the initialization vector.

13. The input/output method of claim 12, wherein the initialization vector and the data are scrambled via an exclusive-OR logic operation.

14. A host system comprising:
a central processing unit (CPU); and
a non-volatile bulk data storage device storing data provided by the CPU,
wherein the non-volatile bulk data storage device comprises:
a storage unit configured to store the data; and
a control part configured to scramble the data and an initialization vector, encipher the scrambled data using a key value, and store the enciphered data in the storage unit,
wherein the control part is further configured to decipher the enciphered data retrieved from the storage unit using the key value, scramble the deciphered data and the initialization vector, and read the scrambled data; and
the initialization vector is generated by processing an address corresponding to the data.

15. The computer system of claim 14, wherein the non-volatile bulk data storage device is one of a solid state disk, a hard disk, and an optical disk.

16. The computer system of claim 15, wherein the optical disk is one selected from a group consisting of; a CD-RW disk, DVD−RW disk, DVD+RW disk, DVD-RAM disk, and Blue-Ray disk.
